(19) United States
(12) Patent Application Publication
(10) Pub. No.: US 2012/0226721 A1
(43) Pub. Date: Sep. 6, 2012

(54) SYSTEMS, APPARATUSES AND METHODS FOR PRESERVING GEOGRAPHIC METADATA

(75) Inventors: Veeramanikandan Raju, Bangalore (IN); Keshava Munegowda, Bangalore (IN); Aashoo Kukreja, Bangalore (IN)

(73) Assignee: Texas Instruments Incorporated, Dallas, TX (US)

(21) Appl. No.: 13/038,900

(22) Filed: Mar. 2, 2011

(51) Int. Cl. G06F 7/00; G06F 12/00; G06F 17/30

(52) U.S. Cl. 707/812; 707/E17.01

(57) ABSTRACT

Systems, apparatuses, and methods for preserving geographic metadata are disclosed. An electronic device may be configured to receive file data from an external device or network, obtain geographic metadata corresponding to the file data, identify non-reserved storage segments for storing the file data, and identify reserved storage segments for storing the geographic metadata. The reserved storage segments may be data clusters or data sectors. In certain embodiments, the reserved storage segments are identified based on the non-reserved storage segments. The electronic device may also be configured to write the file data to the non-reserved storage segments and write the geographic metadata to the reserved storage segments. Additional embodiments include systems, apparatuses, and methods for configuring a data storage device to preserve geographic metadata by storing the geographic metadata in reserved data segments.

### TECHNICAL FIELD

The present disclosure generally relates to metadata, computer file systems and data storage devices.

### BACKGROUND

Computer file systems, such as File Allocation Table (FAT) file systems, are used to store and organize electronic files on hard drives, optical disks, flash memory cards, and other data storage devices. Each file may include several types of metadata, including geographic information intended to describe the location where the file was created or updated. Currently available file systems store a file's geographic metadata in the same region of the data storage device as most or all of the file's additional data.

### SUMMARY

A method for preserving geographic metadata is disclosed. In certain embodiments, the method includes obtaining geographic metadata corresponding to a file data and identifying at least one reserved storage segment in a data storage device for storing the geographic metadata. The method may also include-writing the geographic metadata to the reserved storage segments.

Electronic devices for preserving geographic metadata are also disclosed. In certain embodiments, the electronic device may include a processor configured to obtain geographic metadata corresponding to a file data, identify at least one reserved storage segment in a data storage device for storing the geographic metadata, and write the geographic metadata to the reserved storage segments.

Also disclosed are methods for configuring a storage device to preserve geographic metadata. In certain embodiments, the methods may include determining a number of relevant storage segments and ascertaining an appropriate number of storage segments, based on the number of relevant storage segments for storing geographic metadata. The methods may also include identifying at least one storage segment to be reserved for storing geographic metadata and marking the storage segments as reserved.

In certain embodiments, the determining the number of relevant storage segments include determining a number of clusters in a partition of a selected data storage device. In other embodiments, the determining the number of relevant storage segments may also include determining a number of sectors in a file allocation table. Also, the ascertaining the appropriate number of storage segments for storing geographic metadata may include determining a number of geographic entries per cluster. Additionally, the ascertaining the appropriate number of storage segments for storing geographic metadata may also include determining a number of sectors in a file allocation table.

### BRIEF DESCRIPTION OF THE VIEWS OF DRAWINGS

FIG. 1 illustrates a system for preserving geographic metadata;

FIG. 2 is a block diagram of an electronic device for preserving geographic metadata;

FIG. 3 is a flow diagram of a method for configuring a storage device to preserve geographic metadata according to an embodiment;

FIG. 4 is a flow diagram of a method for preserving geographic metadata according to an embodiment;

FIGS. 5A-5B are block diagrams of file system architectures of data storage devices for preserving geographic metadata according to an embodiment;

FIG. 6 is a relational block diagram of data structures of a data storage device for preserving geographic metadata according town embodiment; and

FIG. 7 is a relational block diagram of other data structures of a data storage device for preserving geographic metadata according to an embodiment.

### DETAILED DESCRIPTION

Currently available computer file systems store a file's geographic metadata in the same region of a data storage device as most or all of the file's additional information (which is often referred to generally as file data). For instance, FAT file systems currently store geographic metadata as file data in the data region or cluster region of a data storage device. As a result, individuals that can analyze or understand a file's data pattern can alter the file's geographic metadata, which can not only render the data inaccurate and misleading, but can also be a source of doubt regarding the geographic metadata of files that have not been tampered with. Accordingly, the present disclosure provides systems, apparatuses and methods for preserving geographic metadata that overcome these and other limitations, in addition to providing currently unavailable benefits.

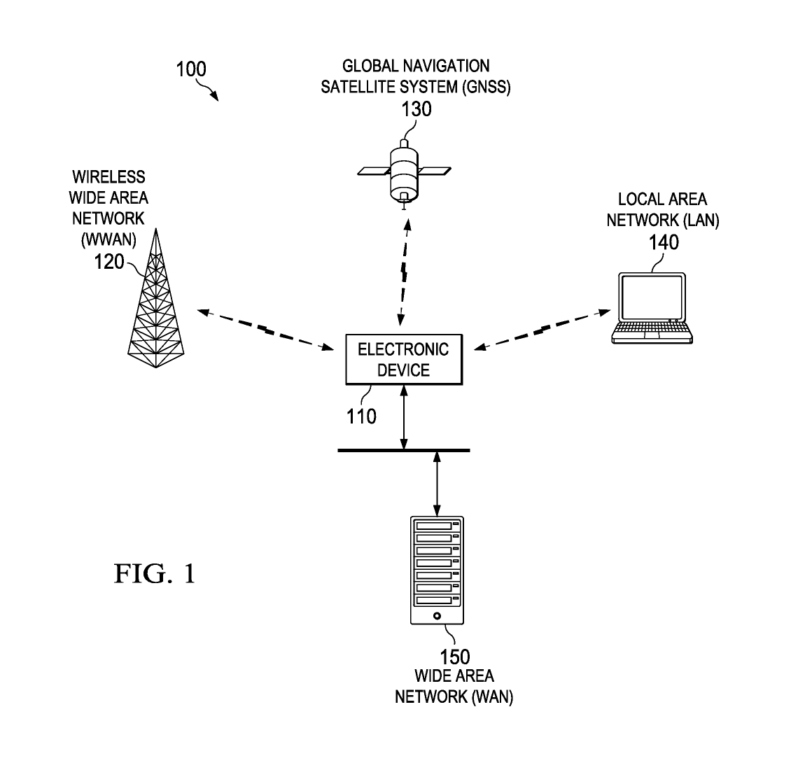

FIG. 1 is a network diagram of a system 100 for preserving geographic metadata. The depicted system 100 includes an electronic device 110, a wireless wide area network (WWAN) 120, a global navigation satellite system (GNSS) 130, a local area network (LAN) 140 and a wide area network (WAN) 150. The system 100 provides a solution for preserving the integrity of a file's geographic metadata from being altered.

The electronic device 110 may include a variety of different electronic devices capable of communicating with one or more networks and/or devices (120-150). For instance, in certain embodiments, the electronic device 110 may be a desktop computer, a server, a laptop computer, a notebook computer, a tablet computer, or a mobile telephone. In other embodiments, the electronic device 110 may be other devices, such as a digital music player, a digital camera, a personal digital assistant (PDA), or a video camera. In yet other embodiments, the electronic device 110 may include a combination of one or more of the foregoing devices.

The electronic device 110 may be configured to reserve one or more storage segments for storing geographic metadata. A storage segment may include one or more types of data defined by a given computer file system. For instance, in certain embodiments, the reserved storage segments are reserved clusters, and, in other embodiments, the reserved storage segments are reserved sectors. The electronic device 110 may also be configured to obtain geographic metadata corresponding to an electronic file and store the geographic metadata in one or more of the reserved storage segments. In this manner, the system 100 can preserve the integrity of the geographic metadata because the reserved storage segments are hidden from the user and/or granted read-only status.

In certain embodiments, the electronic device 110 may receive file data and the corresponding geographic metadata from different sources (120-150). For instance, in certain embodiments, the electronic device 110 may receive a JPEG file from a LAN computer 140 and receive geographic metadata for the JPEG file from the GNSS 130. In some embodiments, the electronic device 110 may also be configured to receive geographic metadata from more than one source (120-150). For instance, the electronic device 110 may be configured to receive longitude and latitude data from the GNSS 130 and country and city data from the WAN 150. As such, it should be appreciated that the electronic device 110 may be configured to communicate with wide variety of external networks and devices (120-150), which cannot all be specifically depicted and/or expressly discussed herein.

The WWAN 120 may include any number of telecommunications technologies, including WiMAX (Worldwide Interoperability for Microwave. Access), GSM (Global System for Mobile Communications), and CDMA (Code Division Multiple Access) technologies. The GNSS 130 may include the Global Positioning System (GPS) and/or the Global Navigation Satellite System (GLONASS). The GNSS could also include satellite systems made available in the future, such as the Indian Regional Navigation Satellite. System (IRNSS), the so-called Galileo Satellite System, and the Beidou Navigation System. The LAN 140 may include routers, computers, mobile phones, microcells or other devices capable of communicating over shorter-range wireless technologies, such as Bluetooth® or any of the IEEE 802.11 standards. The WAN 150 may include additional networks and devices, including routers, servers, switches, LANs, and the Internet. The ever-increasing mobility and interoperability of the devices and technologies discussed above highlight the significance of a solution to preserving the integrity of geographic metadata.

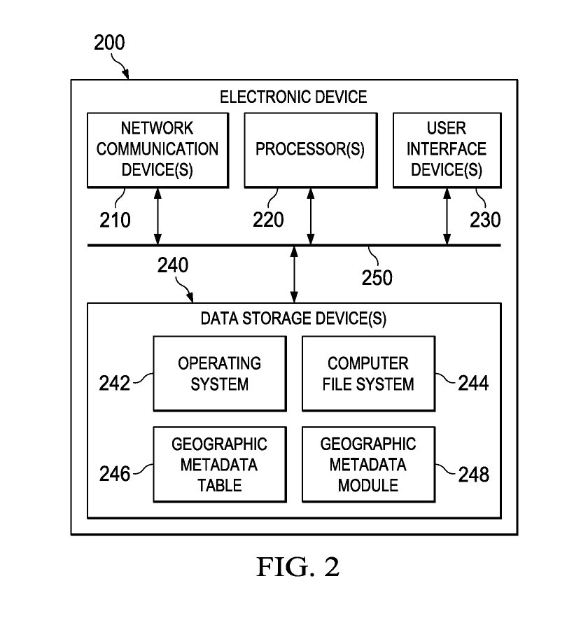

FIG. 2 is a block diagram of an electronic device 200 for preserving geometric metadata. The electronic device 200 includes a network communication device 210, a processor 220, a user interface device 230, a data storage device 240, and centralized circuit system 250. The data storage device 240 includes an operating system 242, a computer file system 244, a geographic metadata table 246, and a geographic module 248. While these software programs and data structures (242-248) may be accurately represented as separate entities in some embodiments, in other embodiments, one or more of the software programs and/or data structures may be combined or otherwise incorporated into another software program and/or data structure. In certain embodiments, the electronic device 200 corresponds to the electronic device 110 discussed above in reference to FIG. 1.

As depicted, the storage device 240 may store or otherwise include physical representations of various types of data, data structures, logical instructions and software programs. For instance, the operating system 242 may include Linux®, Unix®, Windows®, or any other operating system suitable for a given type of electronic device (e.g., a mobile phone, a digital camera, a video camera, etc.). Similarly, the computer file system 244 may include a number of software programs configured to organize and store electronic files and data, such as FAT12, FAT16, and FAT32 file systems. The geographic metadata table 246 may be embodied by a number of data structures, including a set of contiguous data clusters or sectors that have been reserved to store geographic metadata. The geographic metadata module 248 may include executable software instructions, data structures, and other information for obtaining, managing, and/or storing geographical metadata as described herein.

As such, the processor 220 may communicate with the data storage device 240 via the centralized circuit system 250 to reserve one or more storage segments (not shown) for storing geographic metadata. In certain embodiments, the reserved storage segments comprise the geographic metadata table 246. The storage segments may be clusters or data sectors, and the geographic metadata may include any data helpful in describing a geographical area or location. As such, examples of geographic metadata include, but are not limited to, longitude, latitude, a country, a state, a postal code (e.g., a zip code), a point-of-interest location, a street address, and a building or house number, and the like.

In addition, the processor 220 may receive file data (not shown in FIG. 2) from the network communication device 210 and obtain geographic metadata corresponding to the file data. In certain embodiments, the geographic metadata is included in the file data, and the processor 220 obtains the geographic metadata from the file data itself. However, the processor 220 may also obtain the geographic metadata by, for example, generating one or more requests for geographic metadata and communicating the requests; via the network communication device 210, to one or more external devices or networks (see, for example, FIG. 1). In certain embodiments, the processor 220 may obtain geographic metadata in response to receiving; via the user interface device 230, a request to save or otherwise store the file data. The processor 220 may also communicate with the data storage device 240 to store geographic metadata in one or more of the reserved storage segments (i.e., the geographic metadata table 246). Accordingly, since reserved storage segments are hidden from users, the electronic device 200 provides an effective solution to preserving geographical metadata.

Each of the devices (210-250) of the electronic device 200 may be embodied by a variety of different, devices or combinations of devices. For instance, the network communication device 210 may include devices configured to enable the electronic device 200 to communicate with one or more external devices or networks (see, for example, FIG. 1). As such, examples of the network communication device 210 include, but are not limited to, one or more wired network cards, wireless network cards, networking peripheral devices, antennas, transmitters, receivers, and transceivers, including Institute of Electrical and Electronics Engineers (IEEE) interface devices, Universal Serial Bus (USB) devices, Bluetooth® devices, and GNSS interface devices.

Similarly, the processor 220 may include a variety of devices, known to those skilled in the art to facilitate or enable the execution or performance of software instructions, protocols, or logical instructions stored on the data storage device 240. For instance, the processor 220 may be embodied as one or more integrated circuit devices, central processing units (CPUs), microprocessors, or the like. The processor 220 may also include memory devices (e.g., a processor cache), time keeping devices (e.g., a real-time clock (RTC)), and/or additional circuitry or data transmission channels.

The user interface device 230 may also be embodied by a number of different devices or combinations of devices. Examples of user interface devices 230 may include, but are not limited to, pressable buttons, key pads, key boards, scanners, microphones, cameras, video cameras, monitors, touch-sensitive display devices, motion detectors, and/or mouse devices. As such, the user interface device 230 may include any device or set of devices known in the art to enable a user to enter data into and receive from the electronic device 200.

The storage device 240 may also be embodied by a number of different devices or combination on devices. For instance, the storage device 240 may include one or more volatile and/or non-volatile memory devices. Examples of such devices include, but are not limited to, dynamic random access memory (DRAM), static random access memory (SRAM), programmable read-only memory (PROM), erasable programmable read-only memory (EPROM), and electrically erasable programmable read-only memory (EEPROM). Additional examples of such memory devices include hard drives, Flash memory devices, and optical disks.

The centralized circuit system 250 may be various devices configured to among other things, provide or enable communication between the components (210-240) of the electronic device 200. In certain embodiments, the centralized circuit system 250 may be a central printed circuit board (PCB) such as a motherboard, main board, system board, or logic board. The centralized circuit system 250 may also, or alternatively, include other printed circuit assemblies (PCAs) or communication channel media. Accordingly, the scope of the present disclosure may include a wide variety of systems, devices, data structures, and software programs configured to enable the preservation of geographic metadata.

It should be noted that some of the features described in this specification have been presented as modules (e.g., the geographic metadata module), in order to more particularly emphasize their implementation independence. A module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, and the like.

A module may also be at least partially implemented, in software for execution by various types of processors. An identified unit of executable code may, for instance, comprise one or more physical or logical blocks of computer instructions which may, for instance, be organized as an object, procedure, or function. Nevertheless, the executables of an identified module need, not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

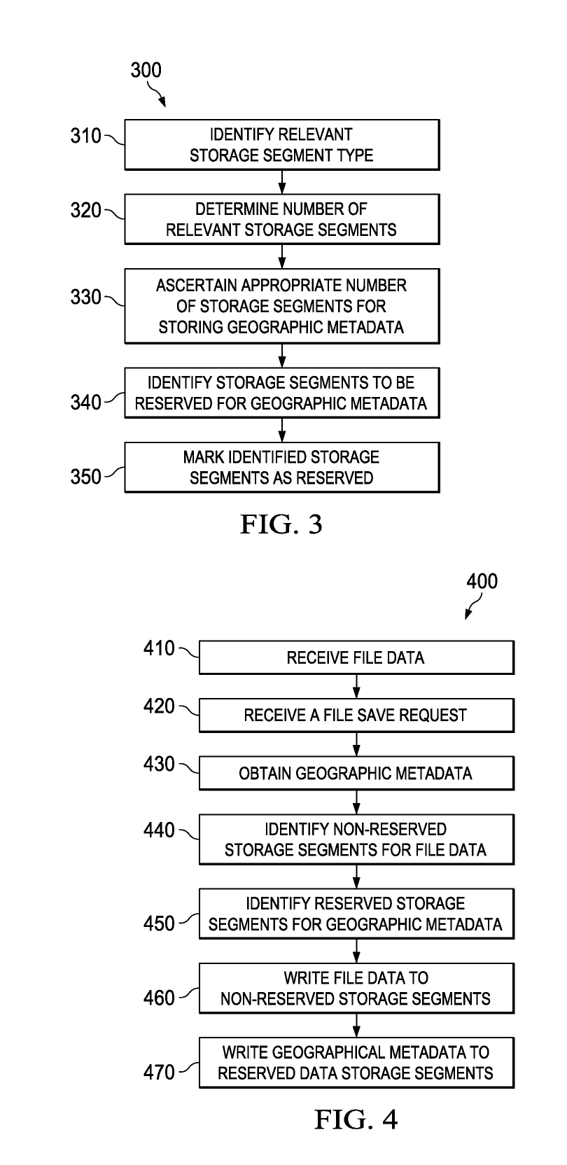

FIG. 3 is a flow diagram of a method 300 for configuring a storage device to preserve geographic metadata. The method 300 includes identifying 310 a relevant storage segment type, determining 320 the number of relevant storage segments, ascertaining 330 an appropriate number of storage segments for storing geographic metadata, identifying 340 storage segments to be reserved, and marking 350 the identified storage segments as reserved. In certain embodiments, these operations (310-350) may be performed by one or more electronic devices (see, FIGS. 1-2).

Identifying 310 a relevant storage segment type may include a processor executing one or more software instructions to determine the type of storage segments (e.g., clusters or sectors) that will be reserved for storing geographic metadata. In embodiments where the geographic metadata will be stored in reserved clusters, the relevant storage segment type may be clusters. However, in embodiments where the geographic metadata will be stored in reserved sectors, the'relevant storage segment type may be sectors, and, more particularly, data sectors that are allocated to FATS. In yet other embodiments, the storage segment type may be given or selected previously and the method 300 might not include operations for identifying 310 the relevant storage segment type.

Determining 320 the number of relevant storage segments may include a processor executing one or more operations or software instructions relating to a current allocation and/or capacity of a selected data storage device. For instance, in embodiments where the relevant data storage segments are clusters, determining 320 the number of relevant storage segments may include determining the total number of clusters in a partition of a data storage device. In such embodiments, the total number of clusters in a partition may be determined by executing the following equation:

C=(A−(R+F*G))/S

where C is the total number of clusters in a partition of a data storage device, A is the total number of sectors in the partition, R is the number of reserved sectors, F is the number of FATs, and G is the number of sectors per FAT. Examples of the reserved sectors (R) include Boot Sectors and FS Information Sectors FAT32).

In certain embodiments, it may be advantageous to determine the number of sectors per FAT prior to determining the total number of clusters. This may be done by executing the following

```
G = ((A − R) * E) / ((2 * E) + (B * S)
If (((A − R) * E) % ((2 * E) + (B * S)) ! = 0) {
    /* Remainder exists after the division operation */
  G = G+1;
}
```

where G is the number of sectors per FAT, A is the total number of sectors in the partition, R is the number of reserved sectors, E is the size of FAT entries, B is the logical/physical block size in bytes, and S is the number of sectors per cluster. The size of FAT entries (E) is 3/2 bytes in FAT12 file systems, 2 bytes in FAT16 file systems, and 4 bytes in FAT32 file systems. Also, in a FAT32 file system, the number of sectors per cluster (S) can depend on the total number of sectors in a partition (A).

However, in embodiments where the relevant data storage segments are data sectors allocated to FATs, determining 320 the number of relevant data storage segments may be different. For instance, determining 320 the number of relevant data storage segments, may include determining the number of sectors per FAT. This may be done by executing the following:

G = (E * (A − R)) / ((2 * E) + K + (B * S))
If ((E * ( A − R)) % (2 * E + K + B * S)) {
/* After devision, reaminder exists */
G = G+1;
}

where G is the number of sectors per FAT, E is the size of FAT entries, A is the total number of sectors in the partition, R is the number, of reserved sectors, K is the number of bytes per entry in the geographic metadata table (see, FIG. 2), B is the logical/physical block size in bytes, and S is the number of sectors per cluster. In certain embodiments, each entry in the geographic metadata table (K) is 8 bytes—4 bytes for as longitude value and another 4 bytes for a latitude value.

Ascertaining 330 an appropriate number of storage segments for storing geographical metadata may involve a processor executing software operations regarding a storage device's current allocation and the number of relevant storage segments. For example, in embodiments where the geographic metadata will be stored in reserved clusters, ascertaining 330 the appropriate number of storage segments for storing geographical metadata may begin by calculating the number of geographical entries per cluster, which may be done by executing the following equation:

T=(B*S)/K

where T is the number of geographical entries per cluster, B is the logical/physical block size in bytes, S is the number of sectors per cluster, and K is the number of bytes per entry in the geographic metadata table (see. FIG. 2).

Calculating the number of geographical entries per cluster (T) may be followed by determining the number of clusters to be reserved for storing geographic metadata (i.e., the size of the geographic metadata table). In some embodiments, this may be done by executing the following:

```
N = (C − (T − 1)) / (T * T)
  /* do the correction */
Z = C − (N * (T+1))
If (Z < T)
  N = N + 1;
Else {
  N = N + ( Z / T)
  If (Z % T) {
    /* after the division operation, remainder exists */
    N = N+1;
  }
}
```

where N is the number of clusters to be reserved for storing geographic metadata, C is the number of clusters. T is the number of geographical entries per cluster, and Z is a variable. In other embodiments, the number of clusters to be reserved for storing geographic metadata may be simplified by executing the following:

```
N = C / (T+1)
If (C % (T+1)) {
  /* after the division operation, remainder exists*/
  N = N+1;
}
```

where N is the number of clusters to be reserved for storing geographic metadata, C is the number of clusters, and T is the number of geographical entries per cluster.

In embodiments where geographic metadata is stored in reserved data sectors instead of reserved clusters; ascertaining 330 the appropriate number of storage segments for storing geographical, metadata may involve the execution of alternative software instructions. For instance, in an embodiment having two FAT tables, ascertaining 330 the number of data sectors for reserving geographic metadata may include executing the following equation:

P=2*G

where P is the number of sectors to be reserved for geographic metadata and G is the number of sectors per FAT. In such embodiments, the number of clusters may be determined by executing the following equation:

C=(A−(R+F*G+P))/S

where C is the number of clusters, A is the total number of sectors in the partition, R is the number of reserved sectors, G is the number of sectors per FAT, P is the number of sectors to be reserved for geographic metadata, and S is the number of sectors per cluster.

Accordingly, similar to the determining 320 operation discussed above, the operations for ascertaining 330 the appropriate number of storage segments for storing geographic metadata may involve a processor executing a series of stored software instructions and mathematical equations that may vary depending on whether geographic metadata will be stored on reserved clusters or sectors. Also, it should be appreciated that additional and/or alternative operations, software instructions, and/or equations may be used to determine 320 the number of relevant storage segments and ascertain 330 an appropriate number of storage segments for storing geographic metadata.

Once an appropriate number of storage segments to be reserved for storing geographic metadata have been ascertained 330, the method 300 may continue by identifying 340 the storage segments to be reserved for geographic metadata. Identifying 340 storage segments to be reserved for geographic metadata may include a processor analyzing a current or projected state of allocation corresponding to a data storage device. For instance, in embodiments where geographic metadata will be stored in reserved clusters, identifying 340 the storage segments to be reserved for geographic metadata may be accomplished by identifying a set of contiguous clusters from cluster 2 to the cluster defined by N+1, where N is the number of clusters to be reserved. The set of contiguous clusters may begin with cluster 2 because clusters corresponding to clusters 0 and 1 are not used.

In embodiments where geographic metadata will be stored in reserved data sectors (instead of clusters), identifying 340 the storage segments to be reserved for geographic metadata may begin with determining the number of data sectors that are already reserved. For instance, FAT file systems currently allocate at least one data sector to be reserved as the Boot Sector, and FAT32 file systems require at least one additional data sector to be reserved for the File System (FS) Information Sector. Identifying 340 the storage segments to be reserved for geographic metadata may also include identifying a set of contiguous sectors begging at sector R and ending at sector P+R−1, where P is the number of sectors to be reserved for geographic metadata and R−1 corresponds to the number of data sectors that are already reserved.

Marking 350 the identified storage segments as reserved may include a processor creating or updating data and/or data structures that corresponds to a computer file system stored in a data storage device. For instance, in embodiments where geographic metadata is to be stored in reserved clusters, marking 350 the identified storage segments as reserved may include accessing a FAT and designating the appropriate FAT entries as reserved by using an appropriate FAT value (e.g., 0x0FFFFFF6). In embodiments where geographic metadata is to be stored in reserved sectors, marking 350 the identified storage segments as reserved may include adding to; or updating, a total count of reserved sectors indicated in a Boot Sector (sector 0) of a data storage device.

In certain embodiments, marking 350 the identified storage segments as reserved amounts to creating a geographic metadata table (FIG. 2). Once the identified storage segments are reserved, the storage segments may be hidden from users and/or have a read-only status, thereby preventing users from altering the geographic metadata stored therein. Accordingly, the present disclosure provides solutions for configuring a data storage device to preserve geographic metadata.

FIG. 4 is a flow diagram of a method 400 for preserving geographic metadata.

The method 400 includes receiving 410 file data, receiving 420 a file save request, obtaining 430 geographic metadata, identifying 440 non-reserved storage segments for storing the file data, identifying 450 reserved storage segments for storing the geographic metadata, writing 460 the file data to the non-reserved data storage segments, and writing 470 geographic metadata to the reserved storage segments. In certain embodiments, the operations (410470) of method 400 may be performed by an electronic device (see, FIGS. 1-2).

Receiving 410 file data may include a processor receiving data corresponding to an electronic file from a communication device. The electronic file may have originated from a number of external devices or networks (see, FIG. 1), and may be in any number of file formats known to those skilled in the art. After receiving 410 the file data, the method 400 may continue by receiving 420 a file save request, which may include a processor receiving, a request from a user, via a user interface device, to store the file data in a data storage device (see, FIG. 2). In certain embodiments, including the operation of receiving 420 a file save request corresponding to the file data may increase an electrical device's efficiency by eliminating the need to, for example, obtain geographic metadata if the file data will never be stored. In other embodiments, however, the method 400 may not include the operation of receiving 420 a file save request and may instead proceed directly to obtaining 430 geographic metadata.

Obtaining 430 geographic metadata may include a processor generating a request for data that describes the current geographic location of an electrical device where the processor is located. The request may be communicated from the processor to a network communication device, and from the network communication device to one or more external devices or networks (see FIG. 1). In such embodiments, obtaining 430 geographic metadata may also include receiving geographic metadata in response to generating and communicating the request. In other embodiments, since it is possible for geographic metadata to be included in the file data, obtaining 430 geographic metadata may also include analyzing the file data for geographic metadata.

Identifying 440 non-reserved storage segments for the file data may include a processor accessing-a computer file system, such as a FAT file system, stored in a data storage device. In such embodiments, the processor may first determine the size of the file data and then the number of clusters necessary for storing the file data. In such embodiments, the processor may also access a FAT to determine which clusters are available to store the file data and also to identify the specific cluster(s) that will be used.

Identifying 450 reserved storage segments for the geographic metadata may include a processor identifying the reserved storage segments based on the non-reserved storage segments that were previously identified for storing the file data. In embodiments where the reserved data segments are reserved clusters, identifying 450 reserved storage segments for the geographic metadata may be determined by, for example, the following:

I₁=2*(X−N−2); and

I₂=(2*(X−N−2))+1

where I₁ and I₂ are each index values of geographic metadata table corresponding to reserved clusters, X is a first data cluster of the file data, and N is the number of reserved clusters. Similarly, in embodiments where the geographic metadata is stored in reserved sectors, identifying 450 reserved storage segments for the geographic metadata may be determined by, for example, the following:

I₁=2*(X−2); and

I₂=(2*(X−2))+1

where I₁ and I₂ are each index values in a geographic metadata table corresponding to reserved sectors and X is a first data cluster of the file data. Accordingly, the identifying 450 reserved storage segments for the geographic metadata may be based on which clusters are used to store the corresponding file data. In certain embodiments, this relationship may also be used to retrieve the file data and corresponding geographic metadata.

Writing 460 the file data to the non-reserved storage segments and writing 470 the geographic metadata to the reserved storage segments may include a processor communicating one or more write commands to a data storage device. In embodiments including a FAT file system, writing 460 the file data to the non-reserved storage segments may also include updating one or more FATs to reflect that the non-reserved storage segments (i.e., the clusters) are storing the file data. Thus, even though the file data is stored in non-reserved storage segments, the geographic metadata corresponding thereto cannot be changed by a user since the geographic metadata was stored in reserved storage segments.

As described above, the systems, devices (i.e., apparatuses) and methods of the present disclosure include multiple solutions for preserving geographic metadata by storing the geographic metadata in, reserved storage segments. It should be appreciated, therefore, that the present disclosure also includes devices and methods for updating and retrieving the geographic metadata. For instance, those skilled in the art will appreciate that the geographic metadata may be updated and/or retrieved by executing one or more retrieval operations based on, for example, the logical relationship used to identify 450 the reserved storage segments based on the non-reserved storage segments previously identified 440. Accordingly, the present invention also includes systems, devices and methods for updating and/or retrieving geographic metadata stored in reserved storage segments.

Additionally, embodiments of the present disclosure include one or more computer programs stored or otherwise embodied on a computer-readable medium, the computer programs being configured to control a processor to perform one or more operations. A computer-readable medium storing, embodying, or encoded with a computer program, or similar language, may be embodied as a tangible data storage device storing one or more software programs that are configured to control a processor to perform one or more operations. Said operations may be, for example, any of the steps or operations described herein. Additionally, a tangible data storage device may be embodied as one or more volatile memory devices, one or more nonvolatile memory devices, and/or a combination of one or more volatile memory devices and nonvolatile memory devices.

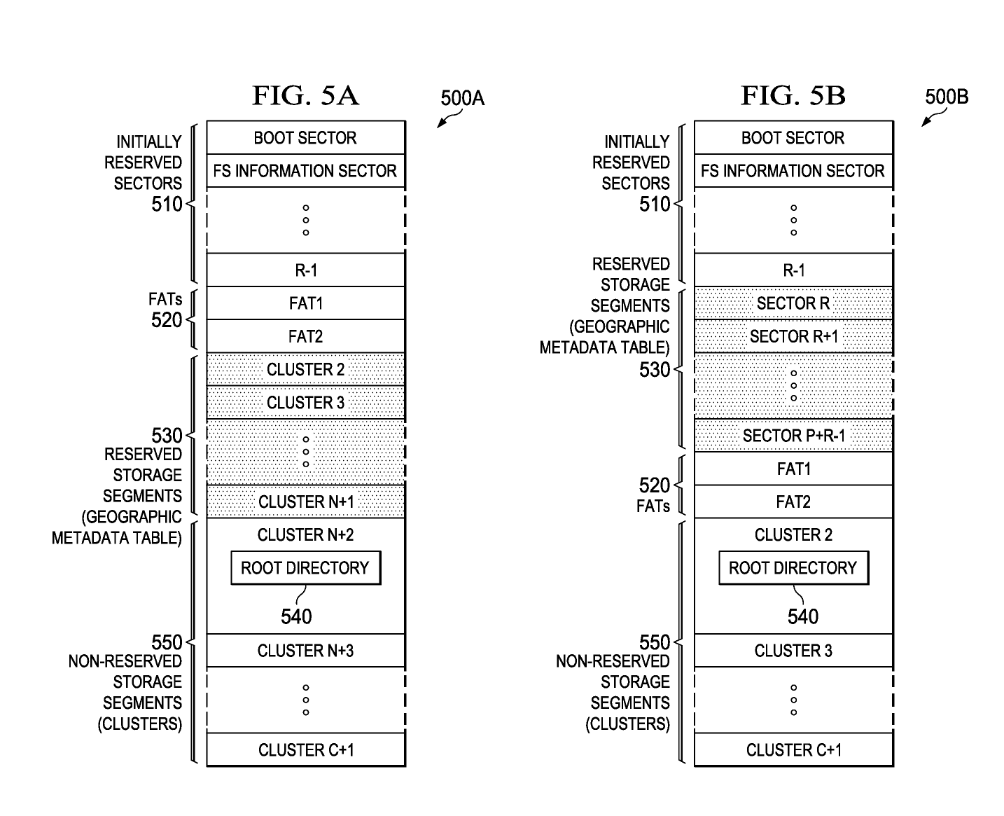

FIGS. 5A-5B are block diagrams of file system architectures 500 of data storage devices for preserving geographic metadata. The file system architectures 500 each include initial reserved sectors 510, FATs 520, reserved storage segments 530, root directories 540, and non-reserved storage segments 550. As discussed below, the depicted data storage devices 500 provide two examples of the manner in which a data storage device may be configured to preserve or otherwise protect geographic metadata.

The data storage devices 500 share several similarities. For instance, each has a set of initially reserved sectors 510, and each has two FATs 520 (for data redundancy). Additionally, each has a set of reserved storage segments 530 (i.e., a geographic metadata table) and a set of non-reserved segments 550 for storing file data. Furthermore, each of the data storage devices 500 are allocated according to a FAT32 file system, as represented by an FS information sector in the initially reserved sectors 510 and a root directory 540 of the non-reserved storage segments 550 (see, Clusters N+2 of FIG. 5A and Cluster 2 of FIG. 5B). However, the reserved storage segments 530 of FIG. 5A are a set of contiguous clusters from Cluster 2 to Cluster N+1, while reserved storage segments 530 of FIG. 5B are a set of contiguous sectors from Sector R to Sector P+R−1.

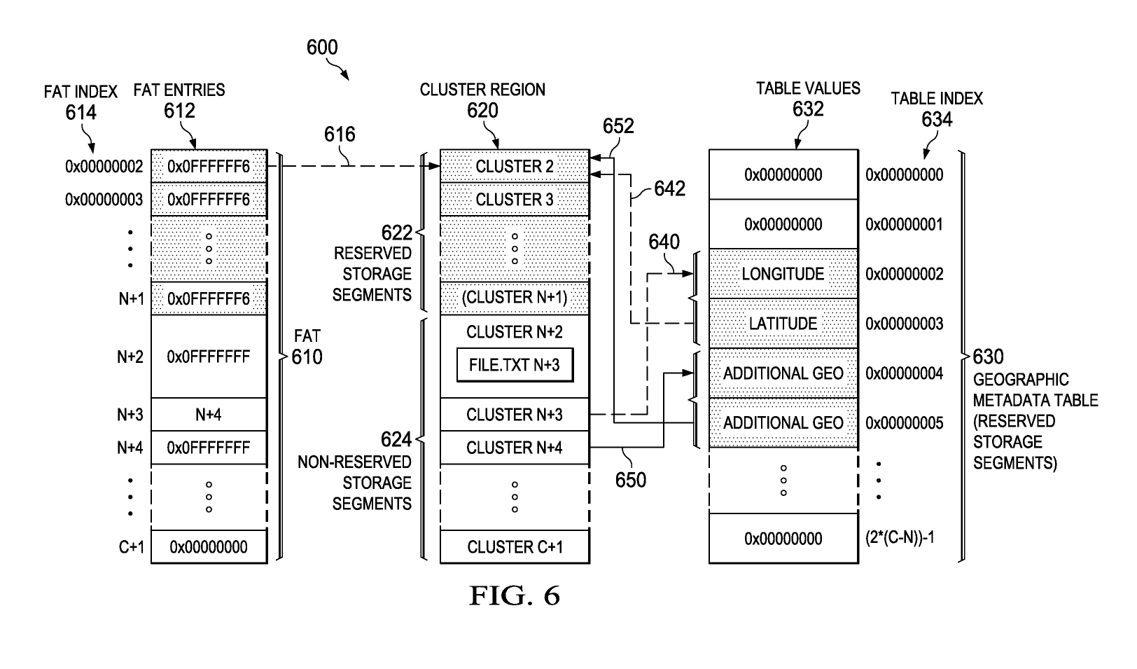

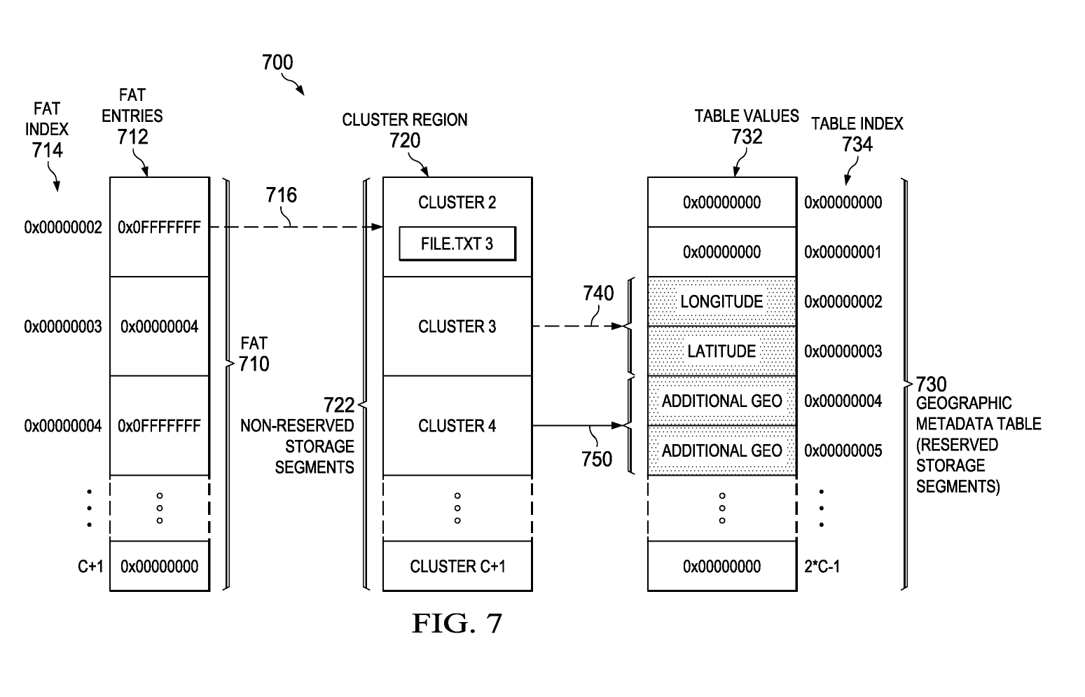

Notably, the reserved storage segments 530 of FIG. 5A are positioned below the initially reserved sectors 510 and FATs 520 since the reserved storage segments 530 are actually reserved clusters. By contrast, the reserved storage segments 530 of FIG. 5B are depicted above the FATs 520 since the reserved storage segments 530 of FIG. 5B are actually reserved sectors. As discussed in detail in reference to FIG. 3, this is due, at least in part, to the manner and sequence in which the reserved storage segments 530 are allocated and subsequently referenced. For similar reasons, the root directory 540 and non-reserved storage segments 550 of FIG. 5A begin at Cluster N+2, whereas the root directory and non-reserved storage segments 550 of FIG. 5B begin at Cluster 2. These and other features are discussed in greater detail below in reference to FIGS. 6-7.

FIG. 6 is a relational block diagram of data structures 600 of a data storage device for preserving geographic metadata. The data Structures 600 include a FAT 610, a cluster region 620, and a geographic metadata table 630. The FAT 610 includes a plurality of FAT entries 612 organized according to a FAT index 614. The cluster region 620 includes a set of reserved storage segments 622 and a set of non-reserved storage segments 624. The geographic metadata table 630 includes a list of table values 632 and a table index 634. The depicted data structures 600 corresponds to embodiments where geographic metadata is preserved by being stored in reserved clusters (see, FIG. 5A).

The FAT 610 includes a list of FAT entries 612 that map to each cluster in the cluster region 620, as represented by the FAT index 614 and the arrow 616. In certain embodiments, if there are ‘C’ number of clusters in the data cluster region 620, the FAT 610 contains ‘C’ number of 4 byte entries. Each FAT entry 612 indicates a status of the corresponding cluster. For instance, the FAT 610 includes the several entries of 0x0FFFFFF6, which indicate that the corresponding clusters (Cluster 2 to Cluster N+1) are reserved. The FAT 610 also includes entries of 0x0FFFFFFF, which indicate that the corresponding clusters (Cluster N+2 and Cluster N+3) are storing the end of a file (EOF) or cluster chain. The FAT 610 further includes the value “N+4” in the FAT entry corresponding to N+3, which indicates that N+3 and N+4 are part of a cluster chain. The entry of 0x00000000, as seen in the entry for Cluster C+1, indicates that Cluster C+1 is available to store data.

As such, the reserved storage segments 622 include a set of clusters from Cluster 2 to Cluster N+1. The reserved storage segments 622 make up the geographic metadata table 630, which is an organized location for storing geographic metadata. As described above in reference to FIG. 3, the actual number of reserved clusters may depend on several factors, including the total number of clusters in a partition, the number of geographic entries per cluster, and more. Similarly, while the non-reserved storage segments 624 are depicted as a set of contiguous clusters beginning with Cluster N+2 and ending with Cluster C+1, the actual number of clusters that make up the non-reserved storage segments 624 may also depend on several factors as described above in reference to FIG. 3.

Consistent with FAT32 file systems. Cluster N+2 is designated as the root directory and corresponds to a FAT entry 612 of 0x0FFFFFFF. By way of example, Cluster N+2 includes a 32 byte entry indicating a file name, FILE.TXT, and a first cluster where the file data for FILE.TXT is stored (i.e., N+3). However, since the file data for FILE.TXT is too large to store in Cluster N+3 alone, the remainder of the file data for FILE.TXT is stored in Cluster N+4, as indicated by the FAT entries 612 for N+3 and N+4.

Also, since the file data for FILE.TXT is stored in Cluster N+3 and Cluster N+4, geographic metadata for FILE.TXT may be stored in the geographic metadata table 630 at table indexes 0x00000002 and 0x00000003, as indicted by the arrows 640 and 650. This relationship between the non-reserved storage segments 624 and the geographic metadata table 630 is discussed in greater detail in FIG. 4. The geographic data may include longitude, latitude, and additional geographic metadata, as depicted. Also, to illustrate the clusters corresponding to these portions of the geographic metadata table 630, arrows 642 and 652 are provided, which point to Cluster 2 of the reserved storage segments. Accordingly, FIG. 6 provides data structures 600 of a data storage device for preserving geographic metadata

FIG. 7 is a relational block diagram of other data structures 700 of a data storage device for preserving geographic metadata. The depicted data structures 700 include a FAT 710, a cluster region 720, and a geographic metadata table 730. Similar to the data structures discussed in reference to FIG. 6, the FAT 710 includes FAT entries 712 organized according to a EAT index 714, and the geographic metadata table 730 includes a list of table values 732 and a table index 734. However, unlike the data storage device of FIG. 6, the cluster region 720 only includes non-reserved storage segments, beginning with Cluster 2 and ending with Cluster C+1. As such, the depicted data structures 700 correspond to embodiments where geographic metadata is stored reserved sectors (see, FIG. 5B).

Similar to the data storage device described in reference to FIG. 6, the FAT 710 includes a list of FAT entries 712 that map to each cluster in the cluster region 720, as represented by the FAT index 714 and the arrow 716. Also, each FAT entry. 712 indicates a status of the corresponding cluster, such as 0x0FFFFFF6 for a reserved cluster, 0x0FFFFFFF for an EOF cluster, 0x00000004 for the next cluster in a cluster chain (see, FAT entry 712 corresponding to FAT index 714 0x00000003), and 0x00000000 for an open cluster (see, Fat entry 712 corresponding to Fat index C+1).

Consistent with FAT32 file systems, Cluster 2 is designated as the root directory and corresponds to a FAT entry 712 of 0x0FFFFFFF. As depicted, Cluster 2 includes a 32 byte entry indicating a file name, FILE.TXT, and a first cluster where the file data for FILE.TXT is stored (i.e., Cluster 3). However, since the file data for FILE.TXT is too large to store in Cluster 3 alone, the remainder of the file data for FILE.TXT is stored in Cluster 4, as indicated by the FAT entries 712 for Cluster 3 and Cluster 4. Also, since the file data for FILE.TXT is stored in Clusters 3 and 4, geographic metadata for FILE.TXT may be stored in the geographic metadata table 730 at table indexes 0x00000002 and 0x00000003, as indicted by the arrows 740 and 750.

The geographic metadata table 730 is defined by a number of reserved Sectors (see, contiguous sectors of FIG. 5B beginning at Sector R and eliding at Sector P+R−1). Also, the association of each cluster in the cluster region 720 and each of the table values 732 of the geographic metadata table 730 may be defined mathematically and has been described in detail above with respect to FIG. 4. The geographic metadata may include longitude and latitude coordinates (see, table values 732 corresponding to table index 734 values 0x00000002 and 0x00000003, respectively), and additional geographic metadata, as depicted (see, table values 732 corresponding to table index 734 0x00000004 and 0x00000005). Accordingly, FIG. 1 provides a relational block diagram of data structures 700 of a data storage device for preserving geographic metadata.

It should be noted that reference throughout this specification to features, advantages, or similar language does not imply that all of the features and advantages should be or are in any single embodiment. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Further, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will understand that the present disclosure, as discussed above, may be practiced with steps and/or operations in a different order, and/or with hardware elements in configurations which are different than those which are disclosed. Therefore, although the invention has been described based upon these preferred embodiments, it should be appreciated that certain modifications, variations, and alternative constructions are apparent and well within the spirit and scope of the invention. In order to determine the metes and bounds of the invention, therefore, reference should be made to the appended claims.

What is claimed is:

1. A method for preserving geographic metadata, the method comprising:
obtaining geographic metadata corresponding to a file data;
identifying at least one reserved storage segment in a data storage device for storing the geographic metadata; and
writing the geographic metadata to the at least one reserved storage segment.

2. The method of claim 1, further comprising:
accessing a file allocation table configured to store a status of non-reserved storage segments; and
identifying at least one non-reserved storage segment for storing the file data.

3. The method of claim 2, wherein the identifying at least one reserved storage segment comprises:
identifying the at least one reserved storage segment based on the at least one non reserved storage segment.

4. The method of claim 2, further comprising:
writing the file data to the at least one non-reserved storage segment; and
updating the file allocation table in accordance with the writing of the file data to the at least one non-reserved storage segment.

5. The method of claim 1, wherein obtaining geographic metadata further comprises:
receiving the file data from an external device; and
communicating a request for the geographic metadata to an external network.

6. The method of claim 1, wherein the identifying at least one reserved storage segment comprises performing at least one of:
determining a number of geographic entries per cluster; and
determining a number of sectors in a file allocation table.

7. The method of claim 6, further comprising performing at least one of
identifying a set of contiguous clusters from cluster 2 to cluster N+1, where N is equal to the appropriate number of storage segments; and
identifying a set of contiguous sectors beginning at sector R and ending at sector P+R−1, wherein P is the appropriate number of sectors to be reserved and R−1 corresponds to the number of initially reserved sectors.

8. The method of claim 1, wherein the writing comprises:
receiving a file save request via at least one user interface device before the obtaining of the geographic metadata.

9. The method of claim 1, wherein the writing the geographic metadata to the at least one reserved storage segment comprises:
writing the geographic metadata to at least one of a data sector and data cluster.

10. An electronic device for preserving geographic metadata, the electronic device comprising:
a processor configured to
obtain geographic metadata corresponding to a file data,
identify at least one reserved storage segment in a data storage device for storing the geographic metadata, and
write the geographic metadata to the at least one reserved storage segment.

11. The electronic device of claim 10, wherein the processor is further configured to
access a file allocation table configured to store a status of non-reserved storage segments, and
identify at least one non-reserved storage segment for storing the file data.

12. The electronic device of claim 11, wherein the processor is configured to
identify the reserved storage segments based on the identified at least one non-reserved storage segment.

13. The electronic device of claim 11, wherein the processor is further configured to
write the file data to the at least one non-reserved storage segment, and
update at least one file allocation table entry accordingly.

14. A method for configuring a storage device to preserve geographic metadata, the method comprising:
determining a number of relevant storage segments;
ascertaining an appropriate number of storage segments for storing geographic metadata based on the number of relevant storage segments;
identifying at least one storage segment to be reserved for storing geographic metadata; and
marking the at least one storage segment as reserved.

15. The method of claim 14, wherein the determining the number of relevant storage segments comprises:
determining the number of clusters in a partition of a selected data storage device.

16. The method of claim 14, wherein the determining the number of relevant storage segments comprises:
determining the number of sectors in a file allocation table.

17. The method of claim 14, wherein the ascertaining the appropriate number of storage segments for storing geographic metadata comprises performing at least one of:
determining a number of geographic entries per cluster; and
determining a number of sectors in a file allocation table.

18. The method of claim 14, wherein the identifying the storage segments to be reserved for storing geographic metadata comprises performing at least one of:
identifying a set of contiguous clusters from cluster 2 to cluster N+1, where N is equal to the appropriate number of storage segments; and
identifying a set of contiguous sectors beginning at sector R and ending at sector P+R−1, wherein P is the appropriate number of sectors to be reserved and R−1 corresponds to the number of initially reserved sectors.

19. The method of claim 14, wherein the marking the specific storage segments comprises:
accessing a file allocation table, and
updating the file allocation table with appropriate file allocation entries.

20. The method of claim 14, wherein the marking the specific storage segments comprises:
accessing a boot sector, and
updating a count of reserved sectors in the boot sector to indicate reserved sectors for storing the geographic metadata.
